(19) United States
(12) Patent Application Publication
(10) Pub. No.: US 2013/0130213 A1
(43) Pub. Date: May 23, 2013

(54) ACTIVITY MONITOR AND ANALYZER WITH VOICE DIRECTION FOR EXERCISE

(71) Applicants: Patricia M. Burbank, Kingston, RI (US); Ying Sun, West Warwick, RI (US)

(72) Inventors: Patricia M. Burbank, Kingston, RI (US); Ying Sun, West Warwick, RI (US)

(73) Assignee: Board of Governors for Higher Education, State of Rhode Island and Providence Plantations, Providence, RI (US)

(21) Appl. No.: 13/475,532

(22) Filed: May 18, 2012

Related U.S. Application Data
(63) Continuation of application No. PCT/US2010/057739, filed on Nov. 23, 2010.
(60) Provisional application No. 61/264,341, filed on Nov. 25, 2009.

(51) Int. Cl. G09B 19/00

(52) U.S. Cl. CPC G09B 19/00
USPC 434/236

(57) ABSTRACT

A system is disclosed for monitoring and analyzing activity of a subject. The system includes a condition setting unit for setting a schedule for the subject in association with a clock, a voice recording and play-back unit for recording a set of personalized messages for the subject, and a motion detection unit for monitoring, in association with the clock, whether an expected activity has occurred. The voice recording and play-back unit plays one of the set of personalized messages responsive to whether the expected activity has occurred.

### PRIORITY

The present application is a continuation application of PCT/US2010/057739 filed on Nov. 23, 2010, which claims priority to U.S. Provisional patent Application Ser. No. 61/264,341 filed Nov. 25, 2009, the entire disclosure of each of which is hereby incorporated by reference in its entirety.

### BACKGROUND

Physical activity is of primary importance in heath promotion, improvement of function, fall prevention, and maintenance of independence and quality of life among older adults. Research has shown that people over the age of 65 have the highest rates of chronic disease, disability and health care use. More than one third of older adults sustain a serious fall each year with 20-30% suffering injuries such as bruises, hip fractures, or head traumas. Falls may result in decreased function, loss of independence, hospitalization and long term care. It has been reported that in the year 2000, direct medical costs totaled $179 million for fatal falls and $19 billion for nonfatal fall injuries. It has also been reported that frailty affects approximately 20% of older adults. Physical activity has been shown to be key to fall prevention, health promotion and maintenance, and even prevention and reversal of frailty among older adults. In addition, the global population in industrialized countries is aging at a rapid rate. It is estimated that in the United States alone, by the year 2030, 20% of the population will be aged 65 or over. Today, only 16% of persons in the United States ages 65-74 report achieving the Surgeon General's recommended activity level of 30 minutes of moderate activity 5 or more days per week. Inactivity increases with age, with older adults over age 75 reporting even less activity.

There is a need for an easy to use device that works to increase physical activity and exercise, thereby improving health and quality of life for older adults, enabling them to maintain functional status and independence for a longer period of time, and reducing health care costs. This will also impact middle-age children who care for aging parents by reducing their time spent care-giving. Research has shown that currently, workers have higher rates of absenteeism related to caring for aging parents than children. These combined factors make a device that increases physical activity and enhances independence among older adults, thus decreasing care-giver burdens, very attractive to older adults, their children, and employers who aim to decrease worker absenteeism. Further, as the population ages, the market for such a device would also increase.

Many types of exercise/physical activity monitors are available from pedometers to sophisticated exercise monitors that also give data on vital signs such as heart rate. For example, some pedometers employ audible outputs that give the data such as distance traveled or the number of steps taken. One of these is marketed specifically for people who are visually impaired, and a talking pedometer with a panic alarm was designed and is marketed specifically for older people by Sentel Security of the United Kingdom.

In addition to these monitors, the fitness industry has developed some advanced programs that track exercise and give feedback. Nike, Inc. of Beaverton, Oreg., has developed a sensor that is worn on a person's shoe and tracks time, pace, distance and calories on the wearer's hand-held device, which provides data that may later be uploaded to a Nike website. Other companies such as Virgin HealthMiles of Framingham, Mass., provide pedometers with downloadable data and a Frequent Walker program that makes a game out of walking with cash or gift cards as rewards. Exercise programs such as iTrainer, iFitness, or iWorkout may be added to hand-held devices such as iPods and iPhones sold by Apple Computer, Inc. of Cupertino, Calif., and give specific instructions for workouts.

Also, mobility monitors sold by Colonial Medical Assisted Devices of Nashua, N.H. to help prevent falls, have pressure sensors that may be placed in a chair or bed. When the person gets up, a pre-recorded voice tells them to “please sit down” and “the nurse will be in soon”. The voice recording is in place of the usual tonal alarm in bed and chair alarms, and the system may even communicate with a nurse call interface.

U.S. Pat. No. 6,582,342 discloses an electronic activity monitor for monitoring the performance of activity such as exercise. The monitor includes an activity detector (a mechanical switch is disclosed) that is responsive to repetitive motion associated with the performance of an exercise. Monitored functions are stated to include, for example, time, rate, distance, repetitions, height and pulse rate, the only motion detector device is a mechanical switch that must be placed in a position in which closure of the switch will occur once for each repetition in a weightlifting exercise. The system provides audible voice output via a speech synthesizer that provides encouragement, coaching and training information. Inputs such as a target repetition rate and a target number of repetitions may be provided through an input interface, and voice data is also stored in a memory. U.S. Pat. Nos. 5,857,939 and 6,251,048 also disclose electronic exercise monitors that use a mechanical switch for monitoring exercise repetitions and provides voice output via a synthesizer.

U.S. Pat. No. 7,512,515 discloses an activity monitoring system that includes a speed sensor for measuring speed and accelerometers for detecting the period of time for which a person on a bike, skis or a snowboard remains aloft. The activity monitoring system also includes a display system for displaying successive sets of speed and loft data, and further includes a method of measuring the amount of “power” a user absorbs over a period of time (e.g., a day). The system is also disclosed to record an amount of “dead time” that a user is not active (skiing or biking) responsive to a user pressing a start/stop button.

U.S. Pat. No. 7,255,437 discloses an activity monitoring system that employs a pair of eyeglasses, wherein the eyeglasses include a pedometer system as well as an output display and one or more speakers for providing audible output from the pedometer system to inform the user of the number of steps taken, distance traveled, calories consumed, duration of activity and speed of travel. The pedometer system is disclosed to include any of an accelerometer, a mechanical or electrical vibration sensor, or a GPS system, and active motion during sports as well as periods of minimum activity (sleeping) are disclosed to be monitored in different embodiments.

U.S. Pat. No. 6,513,532 discloses a diet and activity-monitoring device that includes a body activity monitor within a wristwatch-style device. The body activity monitor includes any of a GPS system, a heart rate monitor or a motion sensor such as an accelerometer. The device is disclosed to communicate wirelessly to a home PC, and permits a user to record audio information during use, for example, to input the type of food consumed by the user.

U.S. Pat. No. 6,254,513 discloses a pedometer system that includes two cantilever-type acceleration sensors in mutually orthogonally disposed orientation, as well as an angle detector sensor. The angle detector sensor includes either a conductive ring that loosely encircles conductive pins, or a small sphere that is free to roll through an optical path between an LED and a light sensor. The system also includes a microprocessor and, responsive to input from a user and output from the sensors, provides calorimeter information on a display.

U.S. Pat. No. 7,242,305 discloses a system for monitoring movement within a house, and in particular, for determining when motion ceases either because of an extended period of inactivity or because the person left the house. The system includes an infrared motion detector and further discloses that ultrasonic, microwave or radar motion detection systems may also be used. The system also includes door sensors for determining whether an outside door has been opened, and generates status reports responsive to a request by a remotely located caregiver.

None of the above patent references, however, provides interactive reminder and motivational information to a user. There remains a need, therefore, for an easy to use device that works to increase physical activity and exercise, thereby improving health and quality of life for older adults, enabling them to maintain functional status and independence for a longer period of time, and reducing health care costs.

### SUMMARY

In accordance with an embodiment, the invention provides a system for monitoring and analyzing activity of a subject. The system includes a condition setting unit for setting a schedule for the subject in association with a clock, a voice recording and play-back unit for recording a set of personalized messages for the subject, and a motion detection unit for monitoring, in association with the clock, whether an expected activity has occurred. The voice recording and play-back unit plays one of the set of personalized messages responsive to whether the expected activity has occurred.

In accordance with a further embodiment, the invention provides a method for monitoring and analyzing activity of a subject, wherein the method includes the steps of setting a schedule for the subject in association with a clock, recording a set of personalized messages for the subject, monitoring, in association with the clock, whether an expected activity has occurred, and playing one of the set of personalized messages responsive to whether the expected activity has occurred.

### BRIEF DESCRIPTION OF THE DRAWINGS

The following description may be further understood with reference to the accompanying drawings in which:

FIG. 1 shows an illustrative diagrammatic view of a hardware system for implementing a system of the present invention in accordance with an embodiment;

FIG. 2 shows an illustrative diagrammatic view of a motion sensor detection system as used in the system of FIG. 1 in accordance with an embodiment of the present invention;

FIG. 3 shows an illustrative diagrammatic view of the steps employed in an exercise monitoring and analyzing process in accordance with an embodiment of the invention;

FIG. 4 shows an illustrative diagrammatic view of the steps employed in a meal monitoring and analyzing process in accordance with an embodiment of the invention; and

FIG. 5 shows an illustrative diagrammatic view of the steps employed in a medication monitoring and analyzing process in accordance with an embodiment of the invention.

The drawings are shown for illustrative purposes only.

### DETAILED DESCRIPTION

The present invention provides a small wearable device intended for use with older adults. The device combines an accelerometer and clock to monitor the type and time of daily activity and inactivity, and to provide encouragement and directions for exercise through time-activated voice recordings. The device is set on a 24 hour clock that will activate after the person puts it on in the morning and will begin with some short stretching exercises. An amount of inactive time may be set so that after a period of inactivity, a motivational recording will play to encourage the person to get up and walk, stretch and/or do specific exercises for a short time. Optionally, the daily activity data recorded by the device may also be uploaded to a personal computer or an internet website for further analysis.

Four types of exercise have been shown to be important for maintaining health and independence: strength, balance, stretching, and endurance exercises. Exercises that have been shown in multiple studies to be especially beneficial for balance and fall prevention among older adults are Tai Chi exercises. Individualized one to three sentence directions for specific exercises of these four types from the National Institute on Aging's Exercise Guide (2009) may be recorded at a beginning level at first, and later advanced as the older person's activity increases.

A device in accordance with an embodiment of the invention will measure the intensity and duration of activity to enable tracking and counting steps. In the evening, for example, if the person's usual habit is watching television, the recorder may be activated on the half hour to encourage the person to do some leg lifts while sitting during commercials, or to get up and walk about. Voice recordings can be made by loved ones or by the person's primary care provider. Suggestions for what to say in the recorded messages (based on the Transtheoretical Model (TTM) of Health Behavior Change and Motivational Interviewing interventions), may be provided, while default recordings may also be available for use. While the device is designed to meet the needs of older adults, it may also be used by people of any age.

Devices of the present invention are different from talking pedometers as they monitors inactivity in addition to activity, and give specific directions for people to increase their activity levels as well as for individualized exercises. Furthermore, the capability for a friend or family member to record personalized caring messages to help motivate the older person to exercise brings not only the motivational message and instruction, but uses the TTM and Motivational Interviewing interventions, combining this with social support, known to increase participation in physical activity.

The invention therefore provides a small wearable device that monitors daily activity and inactivity, and provides encouragement and directions for exercise through time activated voice recordings. An important field of use of this device is monitoring activities and encouraging exercise for the older adult population, although in various further embodiments, the system may be used to assist in meal taking as well as medication taking activities.

Important features of the system include 1) continuous monitoring and real-time analysis of daily activity and inactivity 2) using pre-recorded voice messages to prompt exercise in a timely manner, 3) a programmable list of voice reminders customized to the individual's daily routine, 4) feedback from motion data immediately after each voice reminder to assess the likelihood that the reminder was followed, 5) using motion feedback to implement the sequence of reminders in an interactive and dynamic way, 6) an assessment system that reports a score for the amount of daily exercise at the end of the day, and 7) an optional upload of activity data to a personal computer for further analysis and/or Internet access.

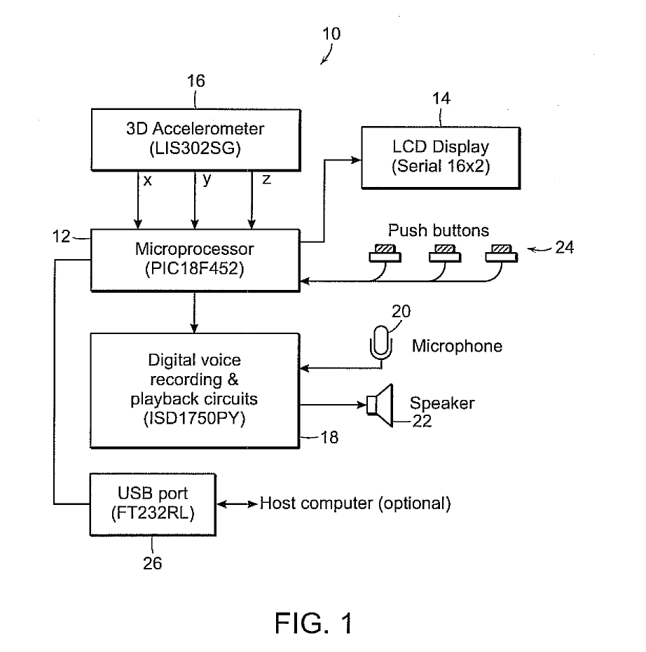

As shown in FIG. 1, a system 10 in accordance with an embodiment includes a microprocessor 12 with an LCD display 14, a motion sensor 16 such as a three-dimensional accelerometer, a clock (included within the microprocessor 12), a digital record/playback integrated circuit 18 with a microphone 20 and a speaker 22 coupled thereto, as well as push buttons 24 for operation control by a user. As an alternative to the accelerometer, a gyroscope or a magnetometer may also be used for motion sensing. The microprocessor 12 may also include an optional communication port 26 such as a universal serial bus (USB) port. The system may run independently as a self-contained unit, and may upload daily activity to another computer for analysis or further transfer via a network to further computers and/or hand held devices.

The motion sensor 16 (such as for example, a LIS302SG three axis MEMS motion sensor sold by STMicroelectronics, Inc. of Carrollton, Tex.), provides analog data to the microprocessor 12 (such as for example, a PIC18F452 microcontroller sold by Microchip Technology Incorporated of Chandler, Ariz.). The microprocessor 12 is also coupled to the display 14, push buttons 24 and USB port 26, as well as the digital record/playback integrated circuit 18. The circuit 18 may, for example, be an ISD1750PY single-chip voice record and playback device as sold by Winbond Electronics Corporation of Taiwan.

The data from the motion sensor (accelerometer, gyroscope or magnetometer) is analyzed by the microprocessor. Applicant has found that by analyzing the type of motions during a pre-programmed time frame immediately after a specific voice instruction, the system may obtain feedback data pertaining to the likelihood that the instruction was followed. This feedback allows the system to decide either to issue the next instruction or to repeat the last instruction. For example, the system issues an instruction directing the user to go to the kitchen, but no motion was detected during the next minute. The system assumes that the instruction was not followed and the same instruction is repeated. Therefore, by analyzing motion data interactively during the pre-programmed instruction sequence, the system is more effective than prior art systems for directing the user to complete a desired task.

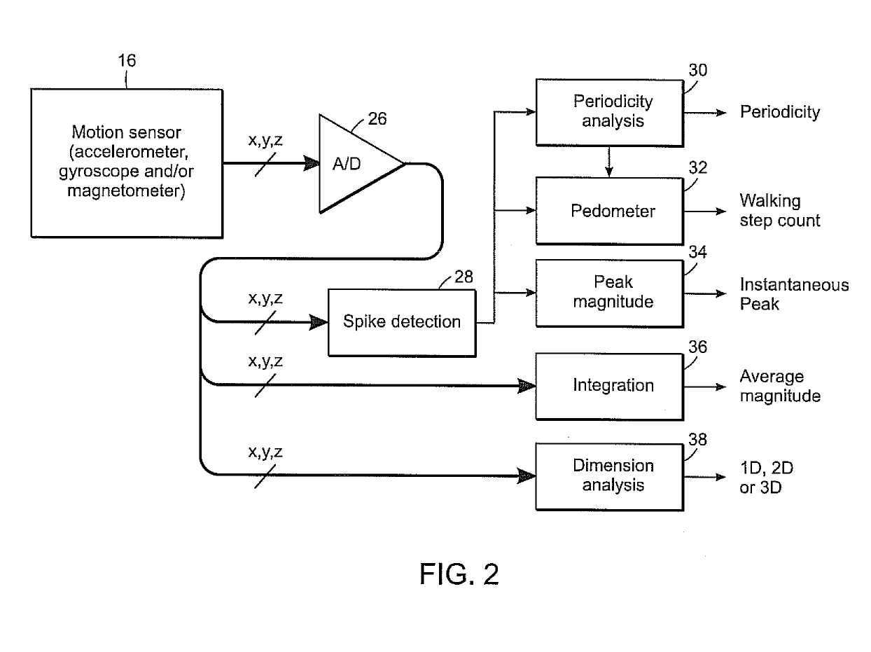

FIG. 2 shows an illustrative diagrammatic view of a motion sensor detection system as used in the system of FIG. 1 in accordance with an embodiment of the present invention. In particular, the motion sensor 16 continuously outputs x, y, z data as shown, and this data is input to an analog to digital (A/D) converter that may be included in the microprocessor 12 of FIG. 1. The digitally converted x, y, z data is then provided to a spike detection unit 20, the output of which is provided to a periodicity analysis unit 30 that monitors periodicity, a pedometer unit 32 that monitors walking step counts, and a peak magnitude unit 34 that monitors instantaneous peak outputs. A spike detection algorithm is used to detect spikes in the signals corresponding to large movements from activities such as walking. The spike detection unit identifies high-frequency, large-magnitude signals; a suitable algorithm for this purpose is disclosed in Microcontroller-based real-time ORS detection, by Sun Y., Suppappola S., Wrublewski T. A., Biomedical Instrumentation & Technology vol. 26, no.6 pp. 477-484 (1992). The x, y, z data is also output to an integration unit 36 that provides an average magnitude, as well as a dimension analysis unit 38 that provides one, two or three dimensional analysis data.

For periodicity analysis, the intervals between adjacent spikes are determined. The periodicity can be assessed by the coefficient of variance (CV), which is defined as the ratio between the standard deviation and the mean of the spike intervals. A small CV indicates a higher degree of periodicity. The spike intervals are also used in the pedometer to improve the accuracy of counting the walking steps. This is accomplished by rejecting spikes that occur too soon after the preceding spikes. The peak magnitude of each spike is determined and use as an indicator of the instantaneous intensity of the activity. The motion signals are also integrated during a fixed interval, such as every minute, to assess the average magnitude of the activity. Finally, the angular velocity in 3D space is determined from the x, y, and z motion signals. This information is useful in assessing the complexity of the motions, either in 1D, 2D, or 3D. A suitable algorithm for the dimension analysis is disclosed in Estimation of 3-D angular motion using gyroscopes and linear accelerometers, by Algrain M C, Saniie J., IEEE Transactions on Aerospace and Electronic Systems vol. 27, no.6, pp. 910-920 (1991).

In short, the 3D motion data is processed by the microprocessor such that information including periodicity, step count, instantaneous peak, average magnitude, and dimensionality of the motions is extracted. This information provides feedback to the system software as to whether the user is following the specific voice directions. The use of motion analysis feedback allows for the implementation of the voice directions in an interactive and dynamic way.

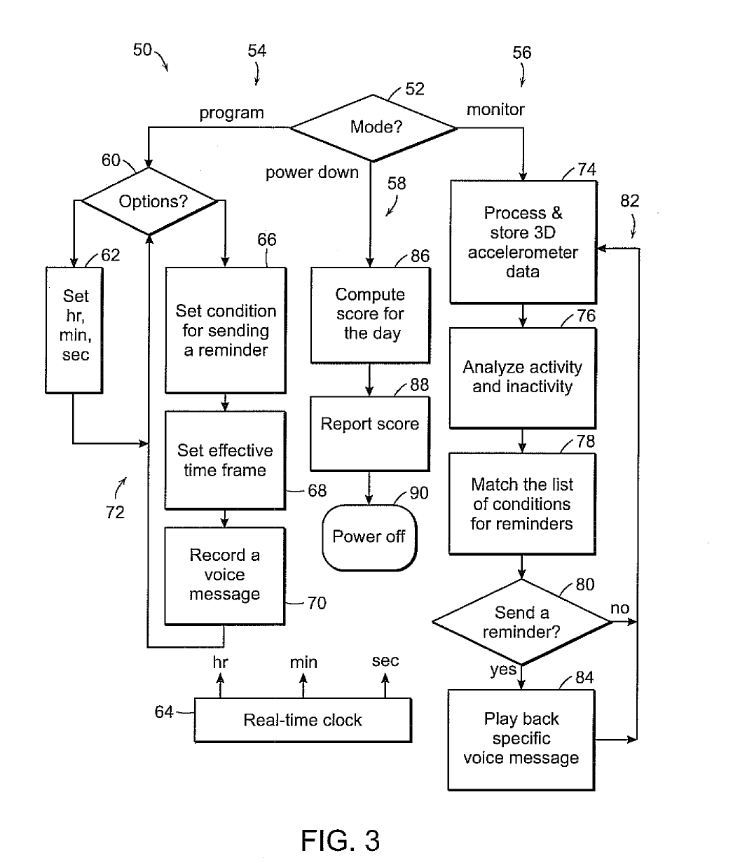

In accordance with an embodiment, the invention provides an activity monitoring system 50 as shown in FIG. 3. During monitoring operation the system continuously analyzes data from the motion detector in terms of the magnitude of motion, duration of the activity and inactivity. The system is preprogrammed to play a specific pre-recorded voice message when the lack of activity or the lack of a certain type of activity is detected during specific time frames. While the device runs independently as a self-contained unit, it does has an input/output port such as a uniform serial bus (USB) port for connecting to a host computer. This optional feature allows for the uploading of activity data to a personal computer, through which the data is accessible by relatives and/or care-givers for further analysis.

In particular, the system 50 functions in one of three modes: program mode, monitor mode, and power down mode. A mode selection determination (step 52) directs whether the system proceeds to program mode (as shown at 54), monitor mode (as shown at 56) or power down mode (as shown at 58). In program mode 54, the system provides an option to the user (step 60) of whether the user wants to set the clock 64 (step 62) or set the conditions for sending reminders (step 66). If setting the conditions for reminders was selected, the system then sets an effective time frame (step 68), then prompts the user to record a voice message and then records the voice message (step 70) and then returns to the options choice (step 60). When the clock and all conditions, time frames and messages are set, the system the user may change modes. Before use therefore, a list of voice reminders is programmed into the device. There are three components for each reminder: 1) the condition of inactivity or lacking certain types of activity, 2) the effective time frame of monitoring this condition, and 3) a pre-recorded voice message for encouraging certain types of exercise.

In monitor mode (as shown at 56) the system processes and stores 3 dimensional motion detector data (step 74) using the hardware discussed above, then analyzes the activity and inactivity data (step 76), then matches the list of conditions for reminders with the activity and inactivity data (step 78). The system then determines whether a reminder needs to be sent (step 80), and if so, a pre-recorded voice recording is played to provide the user with a specific message (step 84), and the process returns to the step of processing the 3 dimensional motion detector data (step 74). If a reminder is not needed, the system directly returns to the step of processing the 3 dimensional motion detector data (step 74).

During use, the device continuously analyzes the data from the 3D accelerometer, classifies the activity in terms of its magnitude and time duration, and tracks the duration of inactivity. The processed activity data is stored in the memory of the device. The list of reminders is constantly checked. If the condition of a list entry is matched, the corresponding voice message is played back. A scoring system is activated when the device is powered off. All activity data stored in the memory is analyzed to provide a score (for instance, between 1 and 10) for the daily activity.

If the user changes the mode to power down mode (as shown at 58) then system computes a score for the day (step 86), then reports the score (step 88) and then powers off (step 90).

The device will be set on a 24 hour clock that will activate after the person puts it on in the morning and will begin with directions for some short stretching exercises. The amount of inactive time can be set so that after a period of inactivity, the recording will play to encourage the person to get up and walk, stretch and/or do specific exercises for a short time. The motion detector and clock will measure the intensity and duration of activity to enable tracking and counting steps. In the evening, for example, if the person's usual habit is watching television, the recorder may be activated on the half hour to encourage the person to do some leg lifts while sitting, or to get up and walk about.

Voice recordings may be made by loved ones or by the person's primary care provider. Suggestions for what to say in the recorded messages (based on the Transtheoretical Model (TTM) of Health Behavior Change and Motivational Interviewing interventions), will be provided in the materials accompanying the product. Default recordings will also be available for use. Short individualized “best practices exercise regimens” may also be recorded. The capability for a friend or family member to record specific caring messages to help motivate the older person to exercise brings not only the motivational message and instruction, but uses the TTM and Motivational Interviewing interventions, combining this with social support, known to increase participation in physical activity (Burbank & Riebe, 2001). The device will be simple and easy to use and the wearer will have the ability to initiate exercise instruction recordings as desired.

The device can run independently without the need to connect to a personal computer. However, the USB port is available on the device allowing for uploading the activity data to a personal computer at the end of the day. Once the data is on the computer, it can be accessed by Internet or email. Other possible interface options include an Internet port and a wireless link such as Bluetooth. If the data is consistently uploaded every day, PC software can be developed to provide more detailed analysis and report trends and progress. This may also be done by a centralized website.

An important feature of this invention is that it monitors and time periods of inactivity in addition to activity and responds with voice recordings to motivate the person to exercise. Another important feature is that specific motivational messages (based on health behavior change research and listed in the instructions to accompany the device when marketed) can be recorded by loved ones or health care professionals to help increase the likelihood that the person will act on their suggestions. In addition, the motion data immediately after each message is analyzed to provide feedback data that allows the system to determine whether to proceed with the next message, repeat the last message, or play a different message. A further important feature is that individualized exercises designed for each person's functional capabilities may be recorded and changed as needed. Further, an assessment system will report a score for the amount of daily exercise at the end of the day. Additionally, an optional upload feature allows for the transfer of the stored activity data to a personal computer for further analysis and/or Internet access.

Devices of the invention must be worn and easily operable by an older person. Each device must be small enough to not be cumbersome and yet have large enough controls to allow for ease of operation. This is possible as older adults learn to operate very small hearing aids and pedometers have been made with larger screens and buttons specifically for use by older adults. An easy to use clip on mechanism will be necessary. In addition, some older adults have hearing difficulties, so a volume control may be necessary and/or the capability to add a tiny wireless speaker that fits over the ear.

From the engineering perspective, the system may include a microprocessor-embedded system that contains an accelerometer and a voice recording/playback integrated circuit as shown in FIG. 1. The functionality for monitoring and managing the daily activity and inactivity is provided by a software program stored in the microprocessor. Based on the same hardware platform, it is possible to provide different functionalities by simply reprogramming the microprocessor. It is also possible to have two or more programs coexisting in the microprocessor. The user can choose which program to run depending on the desired functionality.

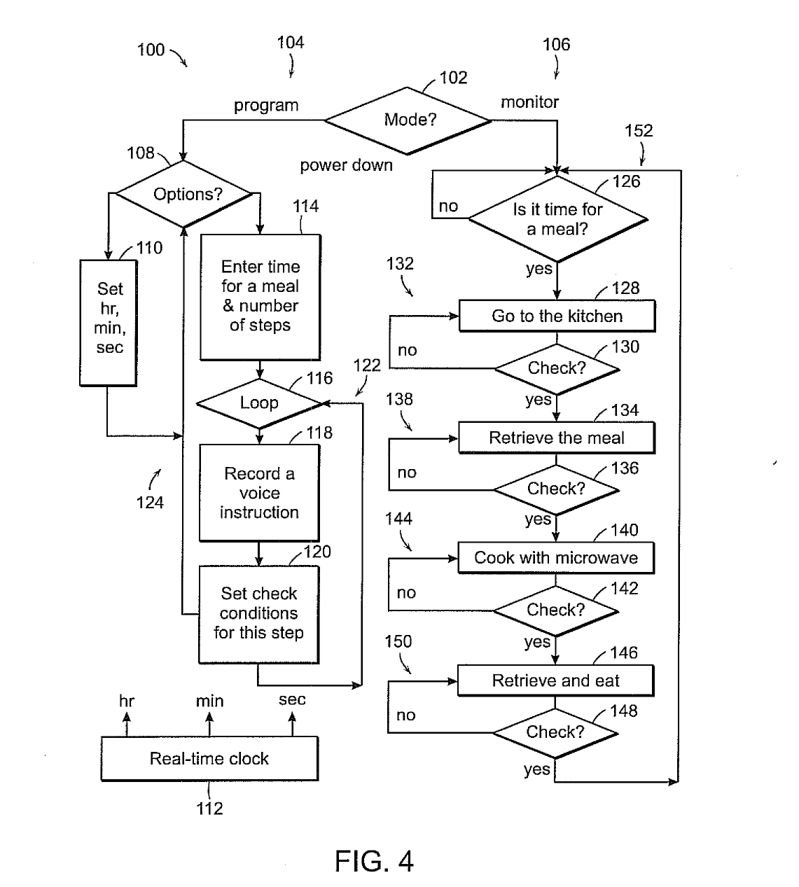

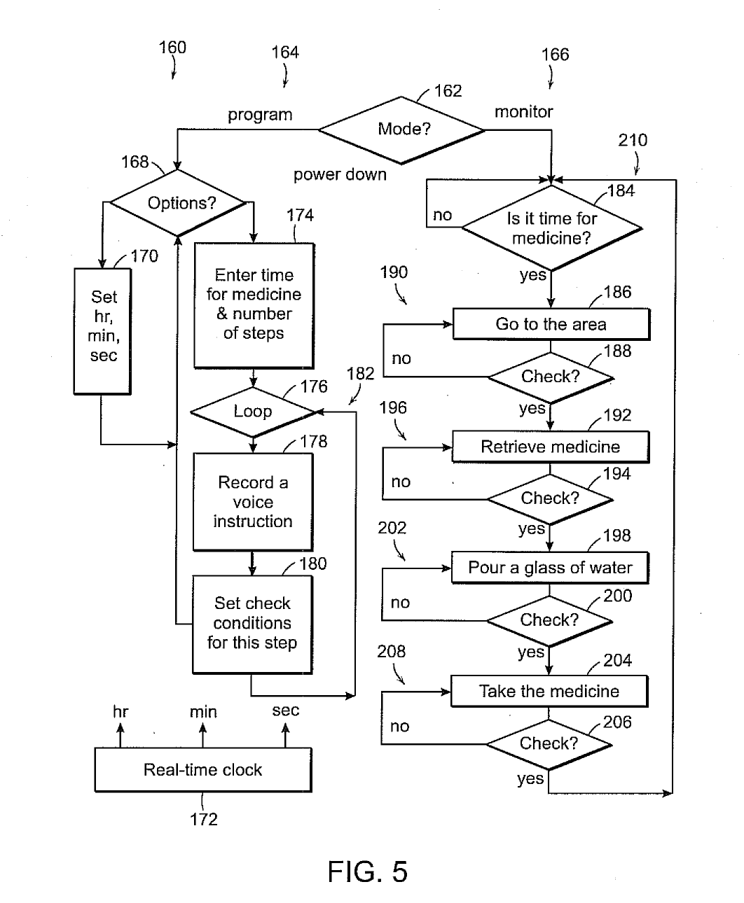

The following describes two additional functionalities that may be implemented on the hardware platform discussed above. First, the Meal Minder system as shown in FIG. 4 provides step-by-step, interactive voice instructions for meal preparation. Second, the Medication Minder system as shown in FIG. 5 provides reminder and voice directions for taking medications as prescribed.

As shown in FIG. 4, the Meal Minder system 100 provides reminders and voice directions for simple microwave meal preparation for people with mild to moderate cognitive impairment. FIG. 4 shows a flowchart of the software program that implements the Meal Minder system based on the same hardware platform as shown in FIG. 1. In particular, the system 100 monitors a mode selection switch (step 102) to determine whether the user has selected a program mode (as shown at 104) or a monitor mode (as shown at 106). In program mode, the system then determines whether the user has selected to have the time set (step 110) on the system clock 112 or to enter user specific data including time for a meal and the number of steps required to prepare the meal (step 114). If the user specific data is being entered, the system then records a voice instruction (step 118), and then sets the conditions for that step (step 120). The system then loops back to record any further required voice instructions (as shown at 122). Once all user specific data has been entered, the system loops back to the being of the options set routine (as shown at 124).

During monitoring mode (as shown at 106), the system queries the clock to determine whether it is time for a meal (step 126). If not, the system loops until this step responds in the affirmative. If it is time for a meal, the system plays a pre-recorded message that advises that it is time to go to the kitchen (step 128). The system then checks to determine whether the expected motions have occurred (step 130), and if not the system continues to prompt that it is time to go to the kitchen to prepare a meal (as shown at 132). Once the system determines that the expected motions have occurred, the system prompts the user to retrieve a meal (step 134), and the system then checks to determine whether the expected motions have occurred (step 136), and if not, the system continues to prompt that it is time to prepare the meal (as shown at 138). Once the system determines that the expected motions for retrieving the meal have occurred, the system prompts the user to cook with the microwave oven (step 140), and the system then checks to determine whether the expected motions have occurred (step 142), and if not, the system continues to prompt that it is time to cook the meal with the microwave oven (as shown at 144). Once the system determines that the expected motions for cooking the meal have occurred, the system prompts the user to retrieve the food and eat it (step 146), and the system then checks to determine whether the expected motions have occurred (step 148), and if not, the system continues to prompt that it is time to retrieve the food and eat it (as shown at 150). Once the system determines that the expected motions for retrieving the food and eating it have occurred, the system returns to the determination of whether it is time for a next meal (as shown at 152).

Like the activity monitoring system therefore, messages may be pre-recorded to begin at a specified mealtime and instruct the person to go to the kitchen. The activity analyzer will be able to sense when the person has moved the pre-set distance from their usual chair to the kitchen. An alternative is to instruct the person to press a button when they're in the kitchen. Then the recording will instruct them to take a numbered meal (e.g., number 1) out of the freezer and put it in the microwave. Since the meals are numbered, the instructions for cooking will be recorded to correspond with each numbered meal. Recorded instructions can be divided into single activities if the person's cognitive abilities require simpler instructions. The person will be instructed to press a button when each activity is completed. These instructions allow a person with cognitive deficits to maintain their independence by being able to prepare a simple microwaveable meal, thus enabling them to stay in their homes for a longer time.

As shown in FIG. 5, the Medication Minder system 160 provides reminder and voice directions for taking medications as prescribed. FIG. 5 shows a flowchart of the software program that implements the Medication Minder based on the same activity monitoring hardware discussed above. In particular, the system 160 monitors a mode selection switch (step 162) to determine whether the user has selected a program mode (as shown at 164) or a monitor mode (as shown at 166). In program mode, the system then determines whether the user has selected to have the time set (step 170) on the system clock 172 or to enter user specific data including time for a meal and the number of steps required to prepare the meal (step 174). If the user specific data is being entered, the system then records a voice instruction (step 178), and then sets the conditions for that step (step 180). The system then loops back to record any further required voice instructions (as shown at 182). Once all user specific data has been entered, the system loops back to the being of the options set routine (as shown).

During monitoring mode (as shown at 166), the system queries the clock to determine whether it is time for a medication (step 184). If not, the system loops until this step responds in the affirmative. If it is time for a meal, the system plays a pre-recorded message that advises that it is time to go to the area where the medication is kept (step 186). The system then checks to determine whether the expected motions have occurred (step 188), and if not the system continues to prompt that it is time to go to the area where the medication is kept (as shown at 190). Once the system determines that the expected motions have occurred, the system prompts the user to retrieve the medication (step 192), and the system then checks to determine whether the expected motions have occurred (step 194), and if not, the system continues to prompt that it is time to prepare the meal (as shown at 196). Once the system determines that the expected motions for retrieving the medication have occurred, the system prompts the user to pour a glass of water (step 198), and the system then checks to determine whether the expected motions have occurred (step 200), and if not, the system continues to prompt that it is time to pour a glass of water (as shown at 202). Once the system determines that the expected motions for pouring a glass of water have occurred, the system prompts the user to take the medicine (step 204), and the system then checks to determine whether the expected motions have occurred (step 206), and if not, the system continues to prompt that it is time to take the medicine (as shown at 208). Once the system determines that the expected motions for taking the medicine it have occurred, the system returns to the determination of whether it is time for a next medication (as shown at 184).

Medications for the week may be prepared into a daily or twice daily medication organizer. The recorded reminder instructions for taking the medications may play at a pre-set time and keep playing every five minutes until the activity sensor registers enough activity to indicate that the person has taken their medications. Instructions will also be given for the person to press a button when they have taken their medications. For people with mild to moderately cognitively impairment, step-by-step instructions can be given to go to the kitchen, pour a glass of water, open their medication container for the proper day and time, take their medications, then push the button when done.

Those skilled in the art will appreciate that numerous modifications and variations may be made to the above disclosed embodiments without departing from the spirit and scope of the invention.

What is claimed is:

1. A system for monitoring and analyzing activity of a subject, said system comprising:
a condition setting unit for setting a schedule for the subject in association with a clock;
a voice recording and play-back unit for recording a set of personalized messages for the subject;
a motion detection unit for monitoring, in association with the clock, whether an expected activity has occurred, wherein said voice recording and play-back unit plays one of the set of personalized messages responsive to whether the expected activity has occurred.

2. The system as claimed in claim 1, wherein said set of personalized messages are recorded by someone familiar with the subject.

3. The system as claimed in claim 1, wherein said motion detection unit includes an accelerometer.

4. The system as claimed in claim 1, wherein said voice recording and play-back unit provides that personalized voice recordings may be made for each subject by a family member.

5. The system as claimed in claim 1, wherein said motion detection includes any of periodicity analysis, walking step count analysis, peak magnitude analysis, integration over time, and dimensional analysis.

6. The system as claimed in claim 1, wherein said system is employed to monitor exercise of the subject.

7. The system as claimed in claim 1, wherein said system is employed to monitor whether the subject has properly eaten scheduled meals.

8. The system as claimed in claim 1, wherein said system is employed to monitor whether the subject has properly taken scheduled medications.

9. The system as claimed in claim 1, wherein said motion detection unit is worn by the subject.

10. A method for monitoring and analyzing activity of a subject, said method comprising the steps of:
setting a schedule for the subject in association with a clock;
recording a set of personalized messages for the subject
monitoring, in association with the clock, whether an expected activity has occurred; and
playing one of the set of personalized messages responsive to whether the expected activity has occurred.

11. The method as claimed in claim 10, wherein said set of personalized messages are recorded by someone familiar with the subject.

12. The method as claimed in claim 10, wherein said step of monitoring whether an expected activity has occurred including reading data from an accelerometer.

13. The method as claimed in claim 10, wherein said voice recording and play-back unit provides that personalized voice recordings may be made for each subject by a family member.

14. The method as claimed in claim 10, wherein said step of monitoring whether an expected activity has occurred includes spike detection.

15. The method as claimed in claim 10, wherein said step of monitoring whether an expected activity has occurred includes any of periodicity analysis, walking step count analysis, peak magnitude analysis, integration over time, and dimensional analysis.

16. The method as claimed in claim 10, wherein said method is employed to monitor exercise of the subject.

17. The method as claimed in claim 10, wherein said method is employed to monitor whether the subject has properly eaten scheduled meals.

18. The method as claimed in claim 10, wherein said method is employed to monitor whether the subject has properly taken scheduled medications.
